(19) United States
(12) Patent Application Publication
(10) Pub. No.: US 2026/0186702 A1
(43) Pub. Date: Jul. 2, 2026

(54) INTERFACE CONTROLLER, INTERFACE CONTROL METHOD AND ELECTRONIC DEVICE

(71) Applicant: NUVOTON TECHNOLOGY CORPORATION, HSINCHU CITY (TW)

(72) Inventor: Cheng-Chieh WANG, zhubei City (TW)

(21) Appl. No.: 19/429,683

(22) Filed: Dec. 22, 2025

(30) Foreign Application Priority Data
Dec. 30, 2024 (TW) 113151429

(51) Int. Cl. G06F 3/06

(52) U.S. Cl. CPC G06F 3/0656; G06F 3/0604; G06F 3/0673

(57) ABSTRACT

An interface controller is electrically connected between a data storage device and a bus system. The interface controller is configured to read and buffer first data of a data block or second data of an associated data block related to the data block from the data storage device, and to transmit the buffered first data or second data to the bus system. The interface controller is further configured to utilize a prediction model to predict whether the data block is associated with one of a plurality of other data blocks. If the data block is associated with one of the plurality of other data blocks, and all of the first data of the data block has been read by the interface controller, the interface controller reads the second data of the associated data block from the data storage device.

### CROSS REFERENCE TO RELATED APPLICATION

This application claims the priority benefit of Taiwan application serial no. 113151429, filed Dec. 30, 2024, the full disclosure of which is incorporated herein by reference.

### BACKGROUND

### Technical Field

The present invention relates to an interface controller, an interface control method, and an electronic device, and more particularly to an interface controller, an interface control method, and an electronic device that utilize a prediction model based on a learning algorithm to predict associated data blocks for data prefetching.

### Description of Related Art

In systems where a large amount of data needs to be stored, external high-capacity data storage devices (i.e., data storage devices external to the bus system) are often required. The interface efficiency of such external data storage devices is typically much lower than that of internal data storage devices (i.e., data storage devices internal to the bus system). As a result, the low interface efficiency of external high-capacity data storage devices has become a primary bottleneck affecting overall system performance.

In the past, in addition to increasing the operating frequency of transmission interfaces, some techniques have incorporated prefetching functions in interface controllers to enhance overall system efficiency. The algorithm used for the prefetching function directly affects the degree of efficiency improvement. Traditionally, a highly efficient algorithm is designed specifically for a given use case. However, this approach may become unsuitable when the use case changes, requiring users to redesign the algorithm for each new scenario.

### SUMMARY

From the above description, it is understood that the objective of the present invention is to provide an interface controller, an interface control method, and an electronic device that utilize a prediction model based on a learning algorithm to predict associated data blocks for data prefetching. This invention effectively improves system efficiency and further allows the prediction model to be retrained based on data access behavior (i.e., data association) when needed without requiring the user to redesign the algorithm.

According to one objective of the present invention, an embodiment provides an interface controller. The interface controller includes an Input/Output (I/O) control unit, a First-In-First-Out/Prefetch (FIFO/Prefetch) buffer, an interface bus control unit, and a prefetch prediction module. The Input/Output control unit is configured to read first data of a data block or second data of an associated data block related to the data block from a data storage device. The FIFO/Prefetch buffer is electrically connected to the Input/Output control unit and is configured to buffer the first data or the second data read by the Input/Output control unit. The interface bus control unit is electrically connected to the FIFO/Prefetch buffer and the Input/Output control unit and is configured to transmit the first data or the second data buffered in the FIFO/Prefetch buffer to a bus system. The prefetch prediction module is electrically connected to the Input/Output control unit, the FIFO/Prefetch buffer, and the interface bus control unit. It is configured to use a prediction model to predict whether the data block is associated with one of a plurality of other data blocks. If the data block is associated with one of a plurality of other data blocks, and a plurality of first data of the data block have been read by the Input/Output control unit, the prefetch prediction module controls the Input/Output control unit to read the second data of the associated data block from the data storage device.

According to one objective of the present invention, an embodiment provides an electronic device. The electronic device includes the aforementioned interface controller, a data storage device, and a bus system, in which the interface controller is electrically connected between the data storage device and the bus system.

According to one objective of the present invention, an embodiment provides an interface control method. The interface control method is executed by an interface controller electrically connected between a data storage device and a bus system. The method includes reading and buffering first data of a data block from the data storage device, and then transmitting the buffered first data to the bus system. The method further includes using a prediction model to predict whether the data block is associated with one of a plurality of other data blocks. If the data block is associated with one of a plurality of other data blocks, and a plurality of first data of the data block have been read by the input/output control unit of the interface controller, the second data of the associated data block is then read from the data storage device. When the FIFO/Prefetch buffer of the interface controller overflows or when the input/output control unit of the interface controller has read the second data of the associated data block, the reading of the second data from the data storage device is stopped. The plurality of second data are then output to the bus system, and another first data of another data block is read from the data storage device.

As compared to the prior art, the interface controller, interface control method, and electronic device provided by the present invention offer greater flexibility. They are not constrained by fixed algorithms in the hardware and may select and train different computational models based on data access behavior, thereby improving the accuracy of data prefetching predictions.

### BRIEF DESCRIPTION OF THE DRAWINGS

FIG. 1 is a block diagram of an electronic device according to an embodiment of the present invention.

FIG. 2 is a block diagram of the interface controller of the electronic device according to an embodiment of the present invention.

FIG. 3 is a schematic diagram illustrating the acquisition of a plurality of data from data blocks within a sliding window according to an embodiment of the present invention.

FIG. 4 is another schematic diagram illustrating the acquisition of a plurality of data from data blocks within a sliding window according to an embodiment of the present invention.

FIG. 5 is a flowchart illustrating the interface control method according to an embodiment of the present invention.

### DETAILED DESCRIPTION

The main objective of the present invention is to provide an interface controller, an interface control method, and an electronic device that can increase the hit rate of prefetching external data by incorporating an inference unit from machine learning, thereby improving the system's operational efficiency. The following detailed description of the possible embodiments of the present invention will be provided in conjunction with the accompanying drawings. However, it should be noted that the implementation details described below are not intended to limit the scope of the claims of the present invention, but rather are provided for the convenience of understanding by those skilled in the art.

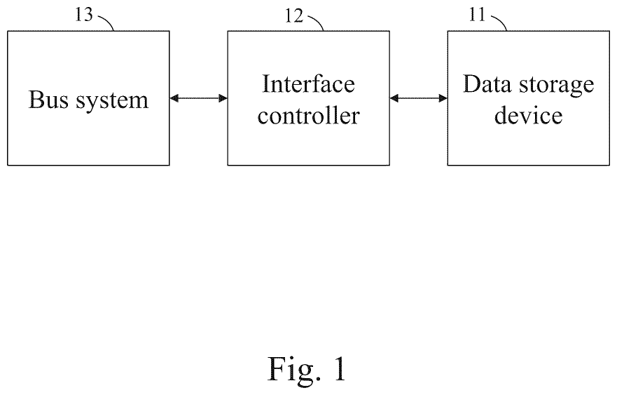

First, referring to FIG. 1, FIG. 1 is a block diagram of an electronic device according to an embodiment of the present invention. The electronic device includes a data storage device 11, an interface controller 12, and a bus system 13, in which the interface controller 12 is electrically connected between the data storage device 11 and the bus system 13. The data storage device 11 stores a plurality of data from a plurality of data blocks, and the interface controller 12 is used to read and buffer data from the data storage device 11, then transmit the buffered data to the bus system 13.

Generally, the bus system 13 internally includes another data storage device, and the interface efficiency of the data storage device within the bus system 13 is superior to that of the data storage device 11 external to the bus system 13. Therefore, the interface controller 12 predicts the data block of the currently read data, identifies other data blocks associated with this data block, and performs data prefetching. In the embodiment of the present invention, the bus system 13 may be a data bus system, and the data storage device 11 may be a volatile memory device or a non-volatile memory device, with the invention not being limited to these configurations.

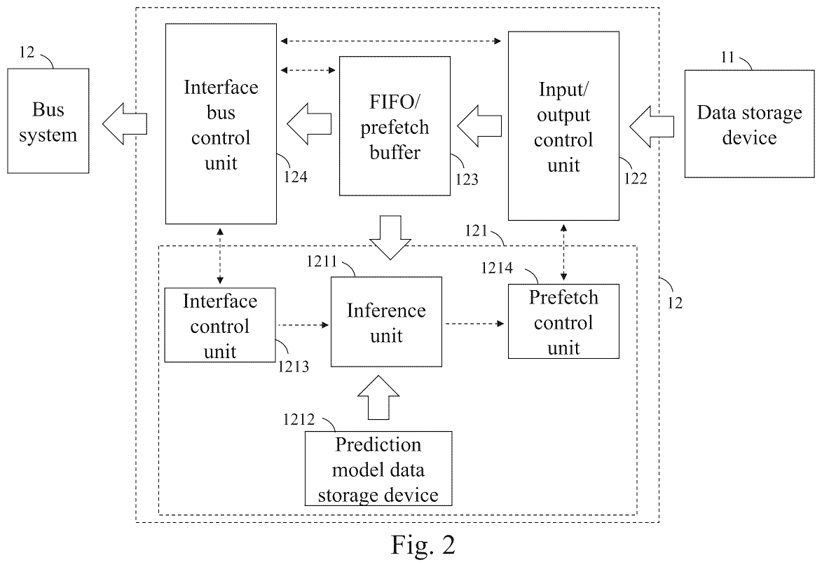

Referring to FIG. 2, FIG. 2 is a block diagram of the interface controller of the electronic device according to an embodiment of the present invention. The interface controller 12 includes a prefetch prediction module 121, an input/output control unit 122, a FIFO/prefetch buffer 123, and an interface bus control unit 124. The input/output control unit 122 is used to read data from a data block in the data storage device. The FIFO/prefetch buffer 123 is electrically connected to the input/output control unit 122 and is used to buffer the data of the data block read by the input/output control unit 122. The interface bus control unit 124 is electrically connected to the FIFO/prefetch buffer 123 and the input/output control unit 122 and is used to transmit the data of the data block buffered in the FIFO/prefetch buffer 123 to the bus system 13.

The prefetch prediction module 121 is electrically connected to the input/output control unit 122, the FIFO/prefetch buffer 123, and the interface bus control unit 124. The data of the data block buffered in the FIFO/prefetch buffer 123 is transmitted not only to the interface bus control unit 124 but also to the prefetch prediction module 121, enabling the prefetch prediction module 121 to make predictions to control the interface controller 12 in performing data prefetching. The prefetch prediction module 121 uses a machine learning algorithm to train the relationships between a plurality of data blocks based on data access behavior. Therefore, the trained prediction model may predict whether the data block of the data read by the input/output control unit 122 is associated with any of a plurality of other data blocks in the data storage device 11.

If the data block is associated with any of a plurality of other data blocks, and the data of the data block has been fully read by the input/output control unit 122 (i.e., the interface bus control unit 124 no longer needs to transmit the data of the data block to the bus system 13), the prefetch prediction module 121 controls the input/output control unit 122 to read the data of the associated data block from the data storage device 11, thereby performing data prefetching. After the input/output control unit 122 acquires the data of the associated data block, the FIFO/prefetch buffer 123 buffers the data of the associated data block, and then the interface bus control unit 124 transmits the data of the associated data block buffered in the FIFO/prefetch buffer 123 to the bus system 13.

If the data block is not associated with any of a plurality of other data blocks, and the data of the data block has been fully read by the input/output control unit 122, the prefetch prediction module 121 controls the input/output control unit 122 to read the data of another data block from the data storage device 11. In simple terms, if no associated data blocks are predicted, data prefetching is not performed, and the data of the next data block is read directly.

The prediction model described above may include at least one of a Support Vector Machine (SVM), a Feedforward Neural Network (FNN), a Recurrent Neural Network (RNN), a Convolutional Neural Network (CNN), a Gated Recurrent Unit (GRU), a Long Short-Term Memory (LSTM) network, and a K-Nearest Neighbors (KNN) classification model, and the present invention is not limited thereto.

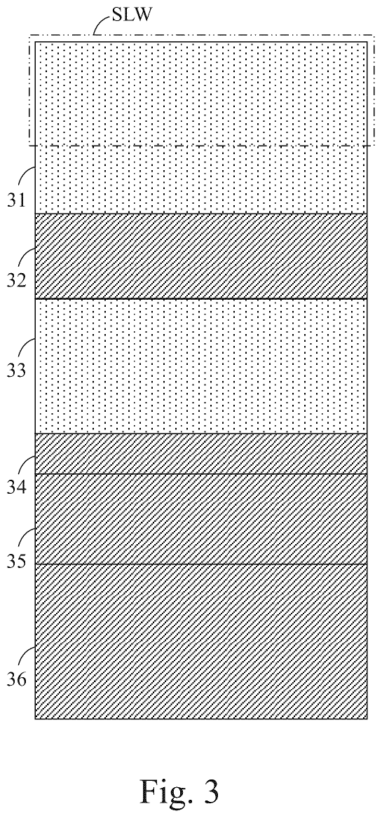

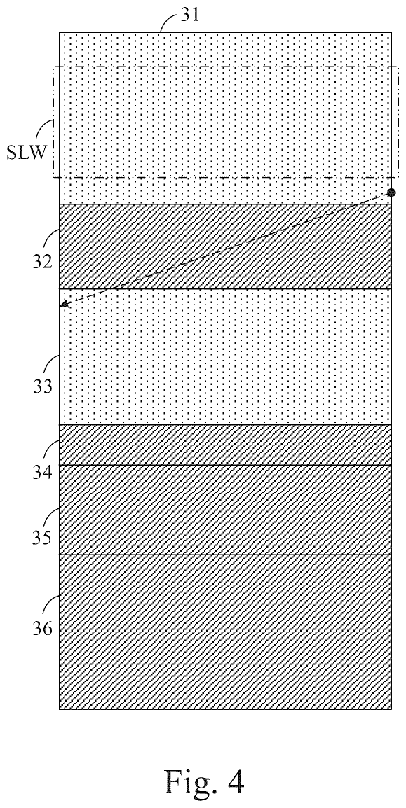

Further, with reference to FIGS. 2 to 4, FIG. 3 is a schematic diagram illustrating the acquisition of a plurality of data blocks within a sliding window, and FIG. 4 is another schematic diagram illustrating the acquisition of a plurality of data blocks within a sliding window in an embodiment of the present invention. The data storage device 11 stores a plurality of data blocks 31 to 36 with a plurality of data, and the prefetch prediction module 121 acquires a plurality of buffered data within the sliding window SLW from the FIFO/prefetch buffer 123. As shown in FIG. 3, the plurality of data located within the sliding window SLW of data block 31 is acquired by the prefetch prediction module 121 for predicting the association of data blocks. Moreover, the sliding window SLW continues to move, and after a period of time, as shown in FIG. 4, the plurality of data located within the sliding window SLW of data block 31 is acquired to predict the association of the data blocks.

From the above, it may be understood that the prefetch prediction module 121 acquires a plurality of buffered data within the sliding window SLW from the FIFO/prefetch buffer 123, which includes at least one of the plurality of data from the data block 31. Then, the prefetch prediction module 121 may use a prediction model to predict whether the data block 31 is associated with any one of a plurality of other data blocks 32 to 36 based on the plurality of buffered data within the sliding window SLW. Moreover, the size of the sliding window SLW may be adjusted according to actual requirements.

In this embodiment, the data block 31 is associated with the data block 33, and the data blocks 32 and 34 to 36 are associated. Therefore, the prediction model is trained such that when a plurality of data located within the sliding window SLW of the data block 31 is received, the prediction model predicts that the data block 31 is associated with the data block 33. Additionally, the prediction model is trained such that when a plurality of data located within the sliding window SLW of the data block 32 is received, the prediction model predicts that the data block 32 is associated with the data block 34.

In one embodiment, the prediction model calculates the association scores between data blocks 31 to 36. For example, the prediction model calculates the association scores between the data block 31 and other data blocks 32 to 36 based on a plurality of buffered data within the sliding window SLW. If the association scores are not greater than a threshold value, the sliding window SLW continues to move. If the association scores exceed the threshold value, the data block with the highest association score (in this case, the data block 33) is predicted to be the associated data block. Subsequently, after the plurality of data from the data block 31 is read by the input/output control unit 122, the prefetch prediction module 121 controls the input/output control unit 122 to read the data from the associated data block (in this case, the data block 33) from the storage device 11, as shown by the dashed line in FIG. 4, jumping from the end of the data block 31 to the beginning of the data block 33.

Please refer to FIG. 2. The prefetch prediction module 121 may include an inference unit 1211 and a prediction model data storage device 1212. The inference unit 1211 is electrically connected to the first-in-first-out (FIFO)/prefetch buffer 123 and is used to acquire a plurality of buffered data from the FIFO/prefetch buffer 123 within a sliding window. The inference unit 1211 uses the prediction model to predict whether the data block is associated with one of a plurality of other data blocks based on the plurality of buffered data within the sliding window. The prediction model data storage device 1212 is electrically connected to the inference unit 1211 and is used to store prediction model data corresponding to the prediction model. The inference unit 1211 reads the prediction model data from the prediction model data storage device 1212 to acquire the prediction model.

The prefetch prediction module 121 may further include an interface control unit 1213 and a prefetch control unit 1214. The prefetch control unit 1214 is electrically connected to the inference unit 1211 and the input/output (I/O) control unit 122. If a data block is associated with one of a plurality of other data blocks, and the plurality of data within the data block has been completely read by the I/O control unit 122, the prefetch control unit 1214 controls the I/O control unit 122 to read the data of the associated data block from the data storage device 11.

Furthermore, when the first-in-first-out (FIFO)/prefetch buffer 123 overflows or the plurality of data of the associated data block has been completely read, the prefetch control unit 1214 transfers control to the interface bus control unit 124. The interface bus control unit 124 then controls the I/O control unit 122 to stop reading the data of the associated data block from the data storage device 11. Instead, the I/O control unit 122 is controlled to read other data of another data block from the data storage device 11.

The interface control unit 1213 is electrically connected to the inference unit 1211 and the interface bus control unit 124 and is configured to monitor the interface bus control unit. When the control of the I/O control unit 122 is transferred to the interface bus control unit 124, the interface control unit 1213 notifies the interface bus control unit 124 to output the plurality of data of the associated data block buffered in the FIFO/prefetch buffer 123 to the bus system 13.

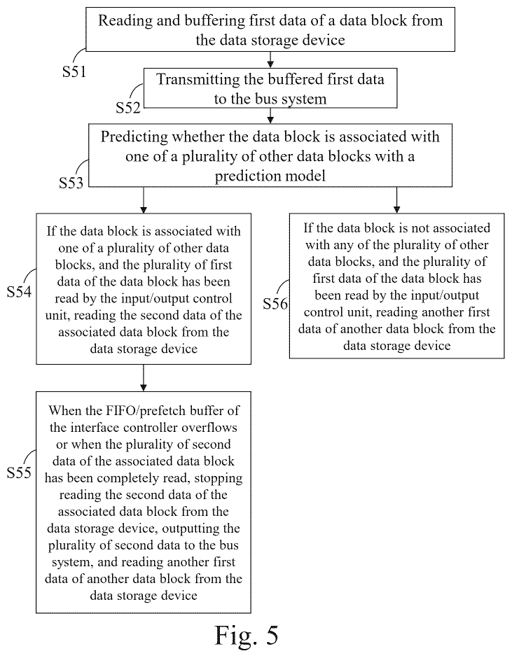

Referring to FIG. 2 and FIG. 5, FIG. 5 is a flowchart illustrating an interface control method according to an embodiment of the present invention. The interface control method is executed in the interface controller 12 and includes the following steps S51 to S56. First, in step S51, the first data of a buffered data block is read from the data storage device 11. Then, in step S52, the buffered first data is transmitted to the bus system 13. Next, in step S53, a prediction model is used to predict whether the data block is associated with one of a plurality of other data blocks.

In step S54, if the data block is associated with one of a plurality of other data blocks, and the plurality of first data of the data block has been completely read by the I/O control unit 122, the second data of the associated data block is read from the data storage device 11. Then, in step S55, when the FIFO/prefetch buffer 123 of the interface controller 12 overflows or the plurality of second data of the associated data block has been completely read, the reading of the second data of the associated data block from the data storage device 11 is stopped. The plurality of second data is output to the bus system 13, and another first data of another data block is read from the data storage device 11. In step S56, if the data block is not associated with any of the plurality of other data blocks, and the plurality of first data of the data block has been completely read by the I/O control unit 122, another first data of another data block is read from the data storage device 11.

In summary, the interface controller, interface control method, and electronic device provided by the present invention have the following features:
(1) By incorporating the inference unit from machine learning, the interface controller increases the hit rate of prefetching external data, thereby improving system operational efficiency;
(2) The system can select different algorithmic models for training based on data access behaviors, thereby enhancing the prediction accuracy of data prefetching;
(3) Because different algorithmic models can be selected for training based on data access behaviors, the system offers greater flexibility compared to fixed hardware algorithms, thereby expanding its range of applications; and
(4) The prediction model can be retrained based on data access behaviors when needed, without requiring users to redesign the algorithm.

The present invention is disclosed herein by way of exemplary embodiments, but any person skilled in the art should understand that the above embodiments are merely for describing the invention and are not intended to limit the scope of the claims of the present invention. Any modifications or substitutions that are equivalent to or similar to the above embodiments should be interpreted as being within the spirit and scope of the present invention. Therefore, the scope of protection of the present invention should be defined by the claims of the patent application.

1. An interface controller, comprising:
an input/output control unit, configured to read first data of a data block or second data of an associated data block related to the data block from a data storage device;
a first-in-first-out/prefetch (FIFO/prefetch) buffer, electrically connected to the input/output control unit and is configured to buffer the first data or the second data read by the input/output control unit;
an interface bus control unit, electrically connected to the FIFO/prefetch buffer and the input/output control unit and is configured to transmit the first data or the second data buffered in the FIFO/prefetch buffer to a bus system; and
a prefetch prediction module, electrically connected to the input/output control unit, the FIFO/prefetch buffer and the interface bus control unit, configured to use a prediction model to predict whether the data block is associated with one of a plurality of other data blocks, if the data block is associated with one of a plurality of other data blocks and a plurality of first data of the data block have been read by the input/output control unit, the prefetch prediction module controls the input/output control unit to read the second data of the associated data block from the data storage device.

2. The interface controller of claim 1, wherein the prefetch prediction module acquires a plurality of buffered data within a sliding window from the FIFO/prefetch buffer, the plurality of buffered data including at least one of the plurality of first data of the data block, and the prefetch prediction module uses the prediction model to predict whether the data block is associated with one of a plurality of other data blocks based on the plurality of buffered data within the sliding window.

3. The interface controller of claim 1, wherein the prefetch prediction module uses the prediction model to calculate a plurality of association scores between the data block and a plurality of other data blocks, and when at least one of the plurality of association scores exceeds a threshold value, the prefetch prediction module predicts the associated data block as the other data block with the highest association score, and after the plurality of first data of the data block has been read by the input/output control unit, the prefetch prediction module controls the input/output control unit to read the second data of the associated data block from the data storage device.

4. The interface controller of claim 3, wherein the prefetch prediction module comprises:
an inference unit, electrically connected to the FIFO/prefetch buffer, configured to acquire a plurality of buffered data within a sliding window from the FIFO/prefetch buffer, the plurality of buffered data including at least one of the plurality of first data of the data block, and the inference unit uses the prediction model to predict whether the data block is associated with one of the plurality of other data blocks based on the plurality of buffered data within the sliding window; and
a prediction model data storage device, electrically connected to the inference unit, configured to store prediction model data corresponding to the prediction model, wherein the inference unit reads the prediction model data from the prediction model data storage device to acquire the prediction model.

5. The interface controller of claim 4, wherein the prefetch prediction module further comprises:
a prefetch control unit, electrically connected to the inference unit and the input/output control unit, wherein if the data block is associated with one of the plurality of other data blocks, and the plurality of first data of the data block has been read by the input/output control unit, the prefetch control unit controls the input/output control unit to read the second data of the associated data block from the data storage device.

6. The interface controller of claim 5, wherein when the FIFO/prefetch buffer overflows or the plurality of second data of the associated data block has been read, the prefetch control unit transfers control to the interface bus control unit to control the input/output control unit to stop reading the second data of the associated data block from the data storage device, and instead controls the input/output control unit to read another first data of another data block from the data storage device.

7. The interface controller of claim 6, wherein the prefetch prediction module further comprises:
an interface control unit, electrically connected to the inference unit and the interface bus control unit, configured to monitor the interface bus control unit, wherein when control is transferred to the interface bus control unit to control the input/output control unit, the interface control unit notifies the interface bus control unit to output the plurality of second data buffered in the FIFO/prefetch buffer to the bus system.

8. An electronic device, comprising:
an interface controller as claimed in claim 1;
a data storage device, electrically connected to the interface controller; and
a bus system, electrically connected to the interface controller.

9. An interface control method, executed by an interface controller electrically connected between a data storage device and a bus system, comprising:
reading and buffering first data of a data block from the data storage device;
transmitting the buffered first data to the bus system;
using a prediction model to predict whether the data block is associated with one of a plurality of other data blocks;
if the data block is associated with one of a plurality of other data blocks, and a plurality of first data of the data block have been read by the input/output control unit of the interface controller, reading the second data of the associated data block from the data storage device; and
when a FIFO/prefetch buffer of the interface controller overflows or when the input/output control unit of the interface controller has read the second data of the associated data block, stopping the reading of the second data from the data storage device, outputting the plurality of second data to the bus system, and reading another first data of another data block from the data storage device.

10. The interface control method as described in claim 9, further comprising:
if the data block is not associated with any of the plurality of other data blocks, and the plurality of first data of the data block have been read by the input/output control unit, reading another first data of another data block from the data storage device.
